(19) United States
(12) Patent Application Publication
(10) Pub. No.: US 2022/0078169 A1
(43) Pub. Date: Mar. 10, 2022

(54) METHODS, SYSTEMS, AND MEDIA FOR PROVIDING SECURE NETWORK COMMUNICATIONS

(71) Applicant: Thien Van Pham, Lacey, WA (US)

(72) Inventor: Thien Van Pham, Lacey, WA (US)

(21) Appl. No.: 17/015,996

(22) Filed: Sep. 9, 2020

(51) Int. Cl. H04L 29/06; H04N 7/15

(52) U.S. Cl. CPC H04L 63/0428; H04N 7/155

(57) ABSTRACT

Mechanisms, which can include systems, methods, and media, for providing secure network communications are provided, the mechanisms comprising: selecting a first channel for a network communication using a hardware processor; passing media content to a user device using the first channel; after a period of time, selecting a second channel for the network communication using the hardware processor; and passing media content to the user device using the second channel.

### TECHNICAL FIELD

The disclosed subject matter relates to systems, methods, and media for providing secure network communications.

### BACKGROUND

Network communications continue to see rapid usage growth as technology enables, and other demands require, people to communicate with each other remotely via the Internet and/or other computer networks. For example, network communications are now widely used for audio and/or video calls, audio and/or video conferencing (e.g., for business meetings, classes, family activities, etc.), sharing live-streamed content, shared interactive and synchronized viewing of common content, etc. However, such network communications can be susceptible to malicious activity. For example, a hacker can hack a video conference and can cause problems within the stream of digital content (e.g., by presenting objectionable content within a video conference, etc.). Recently, some examples of such malicious activity have become known as “zoom bombing.”

Accordingly, it is desirable to provide new methods, systems, and media for providing secure network communications.

### SUMMARY

In accordance with some embodiments, mechanisms, which can include systems, methods, and media, for providing secure network communications are provided.

In some embodiments, systems for providing secure network communications are provided, the systems comprising: memory; and a hardware processor coupled to the memory and configured to: select a first channel for a network communication; pass media content to a user device using the first channel; after a period of time, select a second channel for the network communication; and pass media content to the user device using the second channel. In some of these embodiments, the network communication is a video conference that includes both video and audio. In some of these embodiments, the first channel and the second channel are meeting identifiers. In some of these embodiments, the first channel and the second channel are media sessions, and, optionally, wherein passing media content to the user device using the second channel comprises sending media packets over a media session. In some of these embodiments, the period of time is randomly or pseudo-randomly determined. In some of these embodiments, the period of time is a fixed period. In some of these embodiments, the second channel is randomly or pseudo-randomly determined. In some of these embodiments, identical media content is passed to the user device using both the first channel and the second channel.

In some embodiments, methods for providing secure network communications are provided, the methods comprising: selecting a first channel for a network communication using a hardware processor; passing media content to a user device using the first channel; after a period of time, selecting a second channel for the network communication using the hardware processor; and passing media content to the user device using the second channel. In some of these embodiments, the network communication is a video conference that includes both video and audio. In some of these embodiments, the first channel and the second channel are meeting identifiers. In some of these embodiments, the first channel and the second channel are media sessions, and, optionally, wherein passing media content to the user device using the second channel comprises sending media packets over a media session. In some of these embodiments, the period of time is randomly or pseudo-randomly determined. In some of these embodiments, the period of time is a fixed period. In some of these embodiments, the second channel is randomly or pseudo-randomly determined. In some of these embodiments, identical media content is passed to the user device using both the first channel and the second channel.

In some embodiments, non-transitory computer-readable media containing computer executable instructions that, when executed by a processor, cause the processor to perform a method for providing secure network communications are provided, the method comprising: selecting a first channel for a network communication; passing media content to a user device using the first channel; after a period of time, selecting a second channel for the network communication; and passing media content to the user device using the second channel. In some of these embodiments, the network communication is a video conference that includes both video and audio. In some of these embodiments, the first channel and the second channel are meeting identifiers. In some of these embodiments, the first channel and the second channel are media sessions, and, optionally, wherein passing media content to the user device using the second channel comprises sending media packets over a media session. In some of these embodiments, the period of time is randomly or pseudo-randomly determined. In some of these embodiments, the period of time is a fixed period. In some of these embodiments, the second channel is randomly or pseudo-randomly determined. In some of these embodiments, identical media content is passed to the user device using both the first channel and the second channel.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for providing securing network communications in accordance with some embodiments of the disclosed subject matter.

FIG. 2 shows a schematic diagram of an illustrative system suitable for implementation of mechanisms described herein for providing secure network communications in accordance with some embodiments of the disclosed subject matter.

FIG. 3 shows a detailed example of hardware that can be used in a server and/or a user device of FIG. 2 in accordance with some embodiments of the disclosed subject matter.

### DETAILED DESCRIPTION

In accordance with various embodiments, mechanisms (which can include methods, systems, and media) for providing secure network communications are provided. More particularly, in some embodiments, these mechanisms can provide secure network communications by frequently changing communication channels used to complete those communications and/or by frequently changing encryption keys used to complete those communications.

In some embodiments, the mechanisms described herein can secure network communications, such as communications that are used to transmit media content from, to, or between user devices. For example, in some embodiments, the mechanisms described herein can secure communications that support one-way communication between a pair of user devices, two-way communication between a pair of user devices, one-way communication from a server to a group of user devices (e.g., to stream content to each of the user devices), and/or two-way communication between a server and a group of user devices. As a more particular example, in some embodiments, the mechanisms described herein can secure communications in an audio and/or video conference in which different user devices in the group of user devices are participating. Likewise, in some embodiments, the mechanisms described herein secure communications used when sharing live-streamed content and shared interactive and synchronized viewing of common content.

As described herein, in some embodiments, to provide secure network communications, one or more users participating in network communications can be automatically switched from using one communication channel (or set of communication channels) to another communication channel (or set of communication channels).

A communication channel can be any suitable information or mechanism that enables two or more devices to exchange media content. For example, in some embodiments, two user devices can communicate on a Voice Over IP (VOIP) call using a full duplex media session configured using the Session-Initiation-Protocol (SIP). In this example, the media session is a mechanism which allows media packets to be communicated between the two user devices. The media session is this example can be a communication channel. When the communication channel is changed, a new media session between the two user devices can be created and the new media session used for transferring media packets between the two user devices.

As another example, in some embodiments, a video conference can be conducted between three parties. In connecting to the video conference, each user device can identify a common room number, meeting number, or any other suitable identifier for identifying the video conference. This room number, meeting number, or other identifier (which can be referred to as a conference id.) can be a communication channel. The conference id. can then be associated with media sessions that are configured between each pair of participants. These media sessions can then be used to transfer media packets between the pairs of participants. When the communication channel is changed, a new conference id. can be created, new media sessions for each pair of participants can be created under the new conference id., and media packets transferred between each pair of participants using a corresponding new media session.

In some embodiments, user devices can communicate with each other directly (i.e., without sending media content via an intermediate server). In some embodiments, user devices can communicate with each other by using one or more intermediate servers (i.e., with sending media content via an intermediate server).

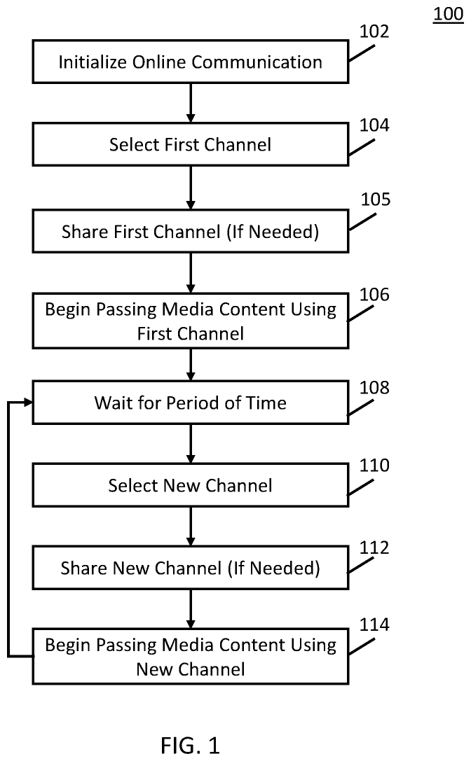

An example of changing channels is now provided. In some embodiments, network communications can initially be configured to take place using a first channel. Once configured, network communications can take place by transmitting media content between participants using the first channel. After some period of time (which can be fixed or variable in some embodiments), a second channel for the communications can be identified. For example, in some embodiments, a different meeting identifier that is to be associated with a video conference can be identified. In some embodiments, each user device can determine the second channel's identity (e.g., a new meeting identifier, and/or any other suitable identifying information). The user devices can then take appropriate action to switch to the new channel. In some embodiments, the user devices can continue to periodically changing channels until communications are terminated. In some embodiments, by repeatedly changing channels, the communications can be protected from a malicious entity that attempts to hack into a channel associated with the communication because the communications are harder to find. Note that more detailed techniques for changing channels are shown in and described below in connection with FIG. 1.

In some embodiments, a new channel identifier can be determined in any suitable manner. For example, in some embodiments, a new channel identifier can be randomly (or pseudo-randomly) selected from among a plurality of possible new channel identifiers. As another example, in some embodiments, a new channel's identifier can be selected from a next available channel identifier in a secret list of channel identifiers. Such a list can be one of many possible lists, and the possible lists can be known in advance by each user device. Which list is being used can be determined by a user device in any suitable manner. For example, in some embodiments, a user device can be told which list is to be used, a user device can determine which list is to be used based on a start time of a communications, and/or a user device can determine which list is to be used based on any other suitable commonly determinable criteria or criterion.

In some embodiments, signal packets and media packets transmitted between devices (e.g., between a server and a user device, between different user devices, etc.) can be encrypted in any suitable manner. In some embodiments, any suitable encryption protocol(s) can be used, such as Public Key Infrastructure (PKI), and/or any other suitable protocol(s). In some embodiments, the devices can each generate a public key and a private key and can exchange public keys, so that a public key can be used to encrypt a packets for a particular recipient device. For example, in some embodiments, media packets transmitted from a server to a user device can be encrypted using a public key of the user device that has been previously shared with the server. As another example, media packets received by the server from a user device can be encrypted using a public key of the server that has been previously shared with the user device. In some embodiments, a recipient device can decrypt a received message using a private key of the recipient device.

In some embodiments, new key pairs can be generated at any suitable points in time. For example, a new key pair can be generated at point in time corresponding to channel change time points. In some such embodiments, new public keys can be shared among the devices in response to the new key pair being generated. In some embodiments, by both changing a channel used to communicate media packets between servers and/or user devices and by changing keys used to encrypt the media packets, the mechanisms described herein can provide dual layers of security.

In some embodiments, any suitable protocol(s) can be used for communications as described herein, such as Transmission Control Protocol/Internet Protocol (TCP/IP), User Datagram Protocol (UDP), Real-Time Protocol (RTP), and/or any other suitable protocol(s).

Turning to FIG. 1, an example 100 of a process for providing secure network communications is shown in accordance with some embodiments of the disclosed subject matter. In some embodiments, blocks of process 100 can be executed by any suitable device, such as a server controlling the network communications or a user device whose user is in charge of a communication (e.g., such as a host of video conference, a party making a call, a person streaming a live media event, a person who configured a synchronized watching event, etc.).

Process 100 can begin at 102 by the process initializing a network communication. Initializing the network communication can be performed in any suitable manner in some embodiments.

For example, in some embodiments, initializing a network communication can include identifying user devices participating in a network communication. In some embodiments, the network communication can correspond to any suitable form of network communications, such as those described elsewhere herein.

As another example, in some embodiments, initializing communication can include authenticating each of the user devices (or their users) prior to granting access to the network communication in any suitable manner. For example, in some embodiments, process 100 can authenticate user devices based on the user devices having access to a Uniform Resource Locator (URL) or other link associated with the network communications. As another example, in some embodiments, process 100 can authenticate each user device by requiring that a user of each user device provide any suitable credentials (e.g., a user id. and a password) and/or information associated with the communications (such as a meeting identifier, a password, a passcode, a PIN, and/or nay other suitable information).

As yet another example, in some embodiments, initializing communication can include generating, for each of the user devices and a server (if included), a public key and a private key to be used for encrypting and decrypting communications between the user devices and server (if included). In some embodiments, the user devices and the server (if included) can exchange public keys with each of the other devices. In some embodiments, key pairs can be updated at any suitable time, as described below in more detail in connection with 112.

Next, at 104, process 100 can select a first channel, or first set of channels, through which communication is to initially take place. As described above, this channel or set of channels can be any suitable information or mechanism that enables two or more devices to exchange media content. For example, a channel can be a meeting identifier or a media session in some embodiments. In some embodiments, the channel or set of channels can be selected in any suitable manner. For example, in some embodiments, the channel or set of channels can be selected randomly, pseudo-randomly, based on a pre-defined list, and/or in any other suitable manner (e.g., as described above).

At 105, process 100 can share identifying information of the first channel with devices that are involved in the communication in some embodiments. For example, if a channel is randomly selected by a user device or a server, the channel id. can be shared with other devices. In some embodiments, 112 can be omitted when devices already know the channel, such as when the user devices use a channel list. The identifying information can be shared in any suitable manner in some embodiments. For example, in some embodiments, process 100 can transmit messages to the devices providing the identifying information. In some embodiments, one or more public keys can be shared when providing the identifying information. Subsequently, this public key can be used to encrypt messages to the device (i.e., a server (if included) or a user device).

Then, at 106, process 100 can begin passing media content between user devices using the selected channel(s). Any suitable media content can be passed and passing media content using the selected channel can be performed in any suitable manner. For example, in some embodiments, media content passed between user devices can correspond to audio content and/or video content transmitted by one or more user devices as part of an audio or video conference, screen-sharing data transmitted by one or more user devices, chat messages transmitted by one or more user devices, and/or any other suitable content. In some embodiments, media content can be passed between user devices in any suitable number of streams, media sessions, and/or any other suitable mechanism for communicating media content.

Note that, in some embodiments, media content passed between the user devices can be encrypted in any suitable manner. For example, in some embodiments, media content being sent to a device (whether a user device or a server) can be encrypted with a public key of the device. Once received, the media content can be decrypted using a private key of the device. In some embodiments in which a server acts as an intermediary between two user devices, media content sent from a first of the user devices to the server can be encrypted using the server's public key. Then the server can decrypt the media content using the server's private key. Next, the server can encrypt the media content using a public key of a second of the user devices and send the encrypted media content to the second of the user devices. Finally, the second of the user devices can receive the encrypted media content and decrypt it using the private key of the second of the user devices.

Note that, in some embodiments, media content can be encoded in any suitable manner. For example, in some embodiments, video content can be encoded using any suitable video encoding protocol(s). As another example, in some embodiments, audio content can be encoded using any suitable audio encoding protocol(s). In some such embodiments, each user device in the group of user devices can decode the content prior to presenting the content.

At 108, process 100 can wait for any suitable period of time and while waiting can continue to pass media content using the current channel. For example, in some embodiments, the duration of time can be any suitable fixed or predetermined duration of time (e.g., one minute, five minutes, ten minutes, and/or any other suitable duration of time). As another example, in some embodiments, the duration of time can be randomly selected from any suitable range of durations. As a more particular example, in some embodiments, the duration of time can be randomly selected to be a random duration from between one minutes and two minutes, five minutes and seven minutes, and/or any other suitable range. Note that, in instances in which the duration of time is randomly selected, a different duration of time can be used each time 108 is executed.

In some embodiments, the waiting period in 108 can be interrupted to allow a channel switch in response to an event taking place during the communications. For example, in some embodiments, when a presentation is begun, a channel switch might take place. As another example, in some embodiments, when a user joins or leaves a communication, a channel switch might take place.

Next, at 110, process 100 can identify a new channel for the communications. As described above, this channel can be any suitable information or mechanism that enables two or more devices to exchange media content. For example, a channel can be a meeting identifier or a media session in some embodiments. In some embodiments, process 100 can identify the new channel in any suitable manner. For example, in some embodiments, this channel can be selected randomly, pseudo-randomly, based on a pre-defined list, and/or in any other suitable manner (e.g., as described above).

At 112, process 100 can share identifying information of the new channel with devices that are involved in the communication in some embodiments. For example, if a channel is randomly selected by a user device or a server, the channel id. can be shared with other devices. In some embodiments, 112 can be omitted when devices already know the channel, such as when the user devices use a channel list. The identifying information can be shared in any suitable manner in some embodiments. For example, in some embodiments, process 100 can transmit messages to the devices providing the identifying information. In some embodiments, one or more public keys can be shared when providing the identifying information. Subsequently, this public key can be used to encrypt messages to the device (i.e., a server (if included) or a user device).

In some embodiments, the identifying information can be included in a message that is encrypted in any suitable manner. For example, in some embodiments, in an instance in which a server (if used) and user devices taking part in a communication are using public and private key pairs, process 100 can encrypt messages containing identifying information using public keys of each of the recipient devices and can transmit the encrypted messages to each device (i.e., the server (if used) and the user devices). Each recipient device can decrypt the message using a private key of the device.

As another example, in some embodiments, each device (i.e., the server (if used) and the user devices) can generate new key pairs prior to the message including the identifying information being transmitted. As a more particular example, in some embodiments, when a server is included, the server can generate a new public key and a new private key and can transmit, to each user device, a message including the server's new public key and indicating that the user device should generate a new key pair. Continuing with this particular example, in some embodiments, each user device can then receive the message from the server and generate a new public key and new private key in response to receiving the message. Continuing further with this particular example, in some embodiments, each user device can then transmit a message to the server that includes the public key of the user device and that is encrypted using the public key of the server. Continuing still further with this particular example, in some embodiments, the server can then transmit the message that includes the identifying information of the new channel (e.g., the new meeting identifier) that is encrypted for each user device using the new public key of each user device. Continuing still further with this particular example, in some embodiments, each user device can then decrypt the received message that includes the identifying information of the new channel using the new private key of the respective user device.

Then, at 114, process 100 can begin passing media content between user devices using the newly selected channel(s). Any suitable media content can be passed and passing media content using the selected channel can be performed in any suitable manner. For example, in some embodiments, media content passed between user devices can correspond to audio content and/or video content transmitted by one or more user devices as part of an audio or video conference, screen-sharing data transmitted by one or more user devices, chat messages transmitted by one or more user devices, and/or any other suitable content. In some embodiments, media content can be passed between user devices in any suitable number of streams, media sessions, and/or any other suitable mechanism for communicating media content.

Note that, in some embodiments, media content passed between the user devices can be encrypted in any suitable manner. For example, in some embodiments, media content being sent to a device (whether a user device or a server) can be encrypted with a public key of the device. Once received, the media content can be decrypted using a private key of the device. In some embodiments in which a server acts as an intermediary between two user devices, media content sent from a first of the user devices to the server can be encrypted using the server's public key. Then the server can decrypt the media content using the server's private key. Next, the server can encrypt the media content using a public key of a second of the user devices and send the encrypted media content to the second of the user devices. Finally, the second of the user devices can receive the encrypted media content and decrypt it using the private key of the second of the user devices.

Note that, in some embodiments, media content can be encoded in any suitable manner. For example, in some embodiments, video content can be encoded using any suitable video encoding protocol(s). As another example, in some embodiments, audio content can be encoded using any suitable audio encoding protocol(s). In some such embodiments, each user device in the group of user devices can decode the content prior to presenting the content.

In some embodiment, when switching from one channel to another for passing media content, the media content can be passed simultaneously using both a current channel and a new channel. In this way, a recipient of the media content can confirm that there is no gap in a presentation of the media content before ceasing to use the current channel. For example, in some embodiments in which a media session is used to provide media packets to a user device, a first media session can be a current channel. A second media session can subsequently be set up to this user device and the same media content can be simultaneously sent over both the first media session and the second media session to the user device so that the user device can then determine when to switch from presenting media packets from the first session. Once the user device has transitioned from the first media session to the second media session, the user device can initiate termination of the first media session.

After 114, process 100 can loop back to 108 and proceed as described above.

In some embodiments, process 100 can loop through 108-114 until the network communications are terminated. For example, in an instance in which the network communications corresponds to an audio or video conference meeting, process 100 can loop through 106-112 until a user device associated with an organizer of the meeting has terminated the meeting.

Note that, in some embodiments, a new public key and a new private key can be generated each time a new channel is identified. In some embodiments, as described above in connection with 112, a server can transmit the new public key to each user device in connection with an instruction for each user device to generate a new key pair and to transmit the new public key back to the server.

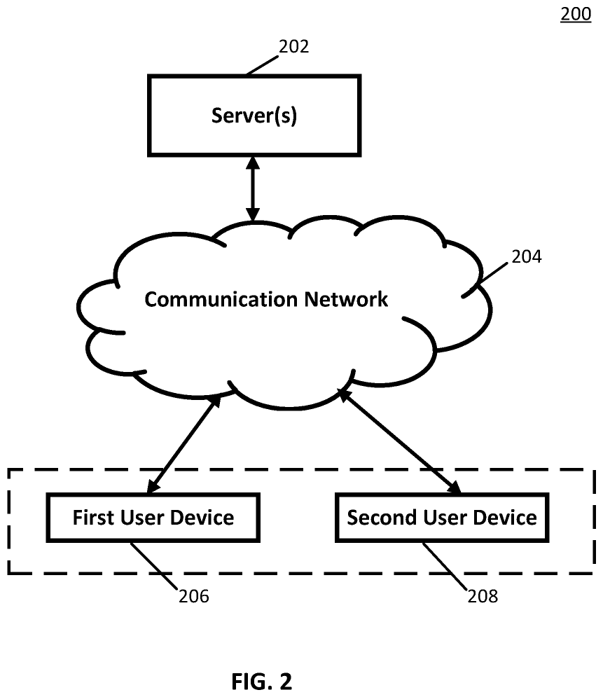

Turning to FIG. 2, an example 200 of hardware for providing securing network communications that can be used in accordance with some embodiments of the disclosed subject matter is shown. As illustrated, hardware 200 can include a server 202, a communication network 204, and one or more user devices, such as first user device 206 and second user device 208.

In some embodiments, server 202 can be any suitable server. In some embodiments, server 202 can perform any suitable function(s), include those described herein.

Communication network 204 can be any suitable combination of one or more wired and/or wireless networks in some embodiments. For example, communication network 204 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 206 and 208 can be connected by one or more communications links to communication network 204 that can be linked via one or more communications links to server 202. In some embodiments, the communications links can be any communications links suitable for communicating data among user devices 206 and 208 and server 202 such as network links, dial-up links, wireless links, hard-wired links, any other suitable communications links, or any suitable combination of such links.

In some embodiments, first user device 206 and second user device 208 can be any suitable user devices for participating in a network communications (e.g., an audio or video conference). For example, in some embodiments, first user device 206 and/or second user device 208 can be any suitable type of mobile device (e.g., a tablet computer, a laptop computer, a wearable computer, a mobile phone, and/or any other suitable type of mobile device), a desktop computer, a vehicle information and/or entertainment system, a media player, a game console, and/or any other suitable type of user device.

Although server 202 is illustrated as one device, the functions performed by server 202 can be performed using any suitable number of devices in some embodiments. For example, in some embodiments, multiple devices can be used to implement the functions performed by server 202.

Although two user devices 206 and 208 are shown in FIG. 2 to avoid over-complicating the figure, any suitable number of user devices, and/or any suitable types of user devices, can be used in some embodiments.

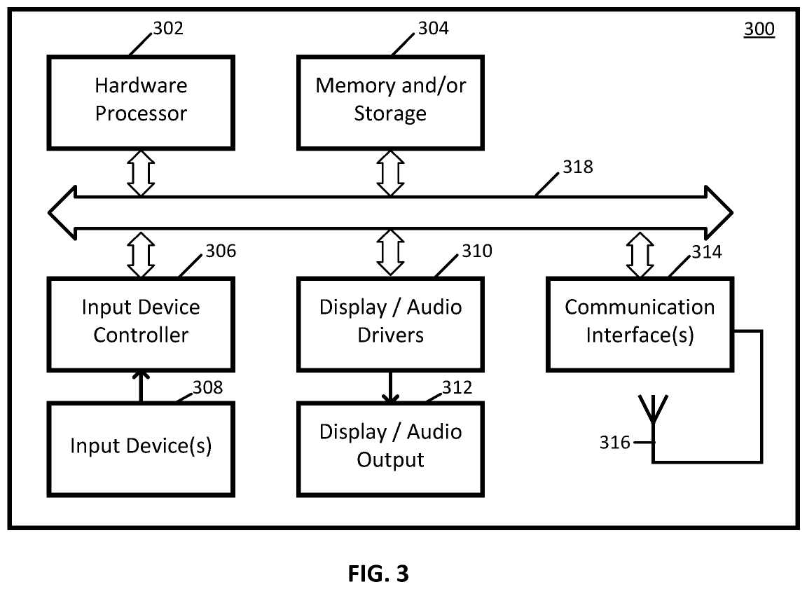

Server 202 and user devices 206 and 208 can be implemented using any suitable hardware in some embodiments. For example, in some embodiments, devices 202, 206, and/or 208 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 302 can be controlled by a server program stored in memory and/or storage of a server, such as server 202. In some embodiments, hardware processor 302 can be controlled by a computer program stored in memory and/or storage of a user device, such as first user device 206 and/or second user device 208.

Memory and/or storage 304 can be any suitable memory and/or storage for storing programs, data, and/or any other suitable information in some embodiments. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some embodiments. For example, input device controller 306 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 310 can be any suitable circuitry for controlling and driving output to one or more display/audio output devices 312 in some embodiments. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks (e.g., computer network 204). For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 204) in some embodiments. In some embodiments, antenna 316 can be omitted.

Bus 318 can be any suitable mechanism for communicating between two or more components 302, 304, 306, 310, and 314 in some embodiments.

Any other suitable components can be included in hardware 300 in accordance with some embodiments.

In some embodiments, at least some of the above described blocks of the process of FIG. 1 can be executed or performed in any order or sequence not limited to the order and sequence shown in and described in connection with the figure. Also, some of the above blocks of FIG. 1 can be executed or performed substantially simultaneously where appropriate or in parallel to reduce latency and processing times. Additionally or alternatively, some of the above described blocks of the process of FIG. 1 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for providing secure network communication are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A system for providing secure network communications, comprising:
memory; and
a hardware processor coupled to the memory and configured to:
authenticate at least two user devices of participants to a network communication using a network communication format;
select a first channel for the network communication between the at least two user devices using the network communication format;
pass media content in the network communication format between the at least two user devices using the first channel;
in response to a passage of a period of time, select a second channel for the network communication using the network communication format between the at least two user devices; and
pass media content in the network communication format between the at least two user devices using the second channel.

2. The system of claim 1, wherein the network communication format is a video conference that includes both video and audio.

3. The system of claim 1, wherein the first channel and the second channel are meeting identifiers.

4. The system of claim 1, wherein the first channel and the second channel are media sessions.

5. The system of claim 4, wherein passing media content to between the at least two user devices using the second channel comprises sending media packets over a media session.

6. The system of claim 1, wherein the period of time is randomly or pseudo-randomly determined.

7. The system of claim 1, wherein the period of time is a fixed period.

8. The system of claim 1, wherein the second channel is randomly or pseudo-randomly determined.

9. The system of claim 1, wherein identical media content is passed to between the at least two user devices using both the first channel and the second channel.

10. A method for providing secure network communications, comprising:
authenticating at least two user devices of participants to a network communication using a network communication format;
selecting a first channel for the network communication between the at least two user devices using the network communication format using a hardware processor;
passing media content in the network communication format between the at least two user devices using the first channel;
in response to a passage of a period of time, selecting a second channel for the network communication using the network communication format between the at least two user devices using the hardware processor; and
passing media content in the network communication format between the at least two user devices using the second channel.

11. The method of claim 10, wherein the network communication format is a video conference that includes both video and audio.

12. The method of claim 10, wherein the first channel and the second channel are meeting identifiers.

13. The method of claim 10, wherein the first channel and the second channel are media sessions.

14. The method of claim 13, wherein passing media content to between the at least two user devices using the second channel comprises sending media packets over a media session.

15. The method of claim 10, wherein the period of time is randomly or pseudo-randomly determined.

16. The method of claim 10, wherein the period of time is a fixed period.

17. The method of claim 10, wherein the second channel is randomly or pseudo-randomly determined.

18. The method of claim 10, wherein identical media content is passed to between the at least two user devices using both the first channel and the second channel.

19. A non-transitory computer-readable medium containing computer executable instructions that, when executed by a processor, cause the processor to perform a method for providing secure network communications, the method comprising:
authenticating at least two user devices of participants to a network communication using a network communication format;
selecting a first channel for the network communication between the at least two user devices using the network communication format;
passing media content in the network communication format between the at least two user devices using the first channel;
in response to a passage of a period of time, selecting a second channel for the network communication using the network communication format between the at least two user devices; and
passing media content in the network communication format between the at least two user devices using the second channel.

20. The non-transitory computer-readable medium of claim 19, wherein the network communication format is a video conference that includes both video and audio.

21. The non-transitory computer-readable medium of claim 19, wherein the first channel and the second channel are meeting identifiers.

22. The non-transitory computer-readable medium of claim 19, wherein the first channel and the second channel are media sessions.

23. The non-transitory computer-readable medium of claim 22, wherein passing media content to between the at least two user devices using the second channel comprises sending media packets over a media session.

24. The non-transitory computer-readable medium of claim 19, wherein the period of time is randomly or pseudo-randomly determined.

25. The non-transitory computer-readable medium of claim 19, wherein the period of time is a fixed period.

26. The non-transitory computer-readable medium of claim 19, wherein the second channel is randomly or pseudo-randomly determined.

27. The non-transitory computer-readable medium of claim 19, wherein identical media content is passed to between the at least two user devices using both the first channel and the second channel.
